(19) United States
(12) Patent Application Publication
(10) Pub. No.: US 2023/0067479 A1
(43) Pub. Date: Mar. 2, 2023

(54) END-WALL CATCHING SYSTEM AND METHOD

(71) Applicant: Perdue Farms, Inc., Salisbury, MD (US)

(72) Inventor: Daniel J. Coady, Warner Springs, CA (US)

(73) Assignee: Perdue Farms, Inc., Salisbury, MD (US)

(21) Appl. No.: 17/464,555

(22) Filed: Sep. 1, 2021

(51) Int. Cl. A01K 45/00

(52) U.S. Cl. CPC A01K 45/005

(57) ABSTRACT

An end-wall catching system configured to removably couple to an end-wall of a mobile poultry enclosure and gather and/or crate live poultry. The end-wall catching system may comprise a conveyor portion including a lifting conveyor belt and a transverse conveyor belt. The end-wall catching system may comprise a harvesting portion for moving the individual ones of the live poultry into one or more crates. The end-wall catching system may comprise a coupling portion configured to couple the end-wall catching system to an end-wall of the mobile poultry enclosure such that responsive to the mobile poultry enclosure moving across a field, the end-wall catching system moves alongside and/or with the mobile poultry enclosure.

### FIELD

The disclosure relates to end-wall catching systems and methods.

### BACKGROUND

Automated catching machines require less labor and offer lower stress harvesting when compared to traditional hand catching methods. Existing catching machines are self-propelled so as to move through chicken houses harvesting broilers. This requires not only self-propulsion but also steering capabilities. Automated catching machines use various conveyer methods to harvest broilers from the chicken house floor into transportation modules. The modules are then placed on flatbed trailers using forklifts.

### SUMMARY

One aspect of the disclosure relates to an end-wall catching system and/or method for gathering and/or crating live poultry. The end-wall catching machine described herein may affix and/or removably couple to an end-wall of a mobile poultry coop. Using the inherent coop mobility, poultry may be harvested into the end-wall as the end-wall catching machine travels towards the birds (affixed and/or coupled to the end-wall of the mobile poultry coop).

The end-wall catching system configured to removably couple to an end-wall of a mobile poultry enclosure and gather and/or crate live poultry may comprise a conveyor portion, a harvesting portion, a coupling portion, and/or other portions. By way of non-limiting example, the mobile poultry enclosure may comprise a 100-500 foot long poultry enclosure that is 50-200 feet wide. Smaller and larger mobile poultry coops with varying dimensions and/or shapes (e.g., having a generally circular, pie shaped, square, rectangular, etc., foot print) are contemplated. The mobile poultry enclosure may be disposed on a chassis and/or include multiple wheels that enable the mobile poultry enclosure to move across a field in one or more directions. The end-wall catching machine may be disposed at one end of the mobile poultry enclosure opposite the direction of movement such that when the mobile poultry enclosure moves across a field, the live poultry inside the mobile poultry enclosure congregate toward the end-wall and/or pass underneath the end wall such that they may be gathered/collected by the end-wall catching machine.

The conveyor portion of the end-wall catching machine may include a lifting conveyor belt, a transverse conveyor belt, and/or other conveyor belts. The lifting conveyor belt may rotate and/or move to lift individual ones of the live poultry off the field on which the mobile poultry enclosure is disposed. The lifting conveyor belt may comprise multiple conveyor belt segments arranged adjacent to each other. The multiple conveyor belt segments may move and/or rotate synchronously to form the lifting conveyor belt. The lifting conveyor belt may move the individual ones of the live poultry to the transverse conveyor belt. In some implementations, the lifting conveyor belt may be arranged perpendicular to the transverse conveyor belt. As such, the lifting conveyor belt may lift the live poultry off the field, moving them horizontally (e.g., towards the end-wall comprising the end-wall catching machine) to a transverse conveyor belt which is arranged perpendicular to the lifting conveyor belt. Once transferred from the lifting conveyor belt to the transverse conveyor belt, the transverse conveyor belt may move the live poultry vertically (e.g., towards the center and/or a corner of the mobile poultry enclosure at and/or near the end-wall). As such, the live poultry may be collected from the field as the mobile poultry enclosure moves, and transported to a specific area (e.g., the corner and/or center of the end-wall) of the mobile poultry enclosure via the lifting and/or transverse conveyor belts. In some implementations, the transverse conveyor belt may run the length (e.g., distance along) and/or nearly the length of the end-wall of the mobile poultry enclosure on and/or near where the end-wall catching system is disposed (i.e., the width of the mobile poultry enclosure). The transverse conveyor belt may comprise multiple conveyor belt segments arranged end-to-end. The multiple conveyor belt segments may move and/or rotate synchronously to form the transverse conveyor belt.

The harvesting portion of the end-wall catching system may be disposed at a convergence of the conveyor portion. For example, the harvesting portion may be located at or near the center and/or a corner of the mobile poultry enclosure at and/or near the end-wall). The harvesting may be configured to move the individual ones of the live poultry into one or more crates.

The end-wall catching system may include a coupling portion. The coupling portion may be configured to couple the end-wall catching system to an end-wall of the mobile poultry enclosure. As such, responsive to the mobile poultry enclosure moving across a field, the end-wall catching system may move alongside and/or with the mobile poultry enclosure. In some implementations, the coupling portion may be configured to couple the end-wall catching system to an exterior of the end-wall of the mobile poultry enclosure. A skirt on a bottom portion of the end-wall of the mobile poultry enclosure may be configured to lift such that when the mobile poultry enclosure moves across the field, the individual ones of the live poultry pass under the end-wall to the end-wall catching system to be lifted off the field by the lifting conveyor belt.

In some implementations, the coupling portion may be configured to couple the end-wall catching system to an interior of the end-wall of the mobile poultry enclosure. As such, responsive to the mobile poultry enclosure moving across the field, the end-wall catching system runs into the individual ones of the live poultry such that they are lifted off the field by the lifting conveyor belt.

The harvesting portion of the end-wall catching system may comprise a movable harvesting conveyor belt that moves the individual ones of the live poultry into the one or more crates. The harvesting conveyor belt may comprise multiple conveyor belt segments arranged adjacent to and/or end-to-end with each other. The multiple conveyor belt segments may move and/or rotate synchronously to form the harvesting conveyor belt. By way of non-limiting example, the harvesting portion may include multiple crates disposed on a rotating platform.

In some implementations, the end-wall catching system may be collapsible. For example, the conveyor portion may be collapsible into a stored position and/or the harvesting portion may be detachable. The stored position may have a smaller surface area and/or footprint than a deployed position.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise. As used in the specification and in the claims, the distinctions “first”, “second”, and/or “third” are used for clarity and distinction purposes and do not indicate order unless the context clearly dictates otherwise.

### BRIEF DESCRIPTION OF THE DRAWINGS

FIG. 1 illustrates an example end-wall catching system coupled to mobile poultry enclosure, in accordance with one or more implementations.

FIG. 2 illustrates a segment of a conveyor portion disposed at an exterior of an end-wall of the mobile poultry enclosure, in accordance with one or more implementations.

FIG. 3 illustrates a side view of a conveyor portion disposed at an exterior of an end-wall of the mobile poultry enclosure, in accordance with one or more implementations.

FIG. 4 illustrates a side view of the harvesting portion of the end-wall catching system with one or more crates, in accordance with one or more implementations.

FIG. 5 illustrates a side view of the harvesting portion of the end-wall catching system with one or more crates, in accordance with one or more implementations.

FIGS. 6A and 6B illustrate an end-wall catching system in a collapsed position, in accordance with one or more implementations.

FIG. 6C illustrates an end-wall catching system in a collapsed position on a flatbed trailer, in accordance with one or more implementations.

FIG. 7 illustrates a method for removably coupling an end-wall catching system to an end-wall of a mobile poultry enclosure and gathering and/or crating live poultry, in accordance with one or more implementations.

### DETAILED DESCRIPTION

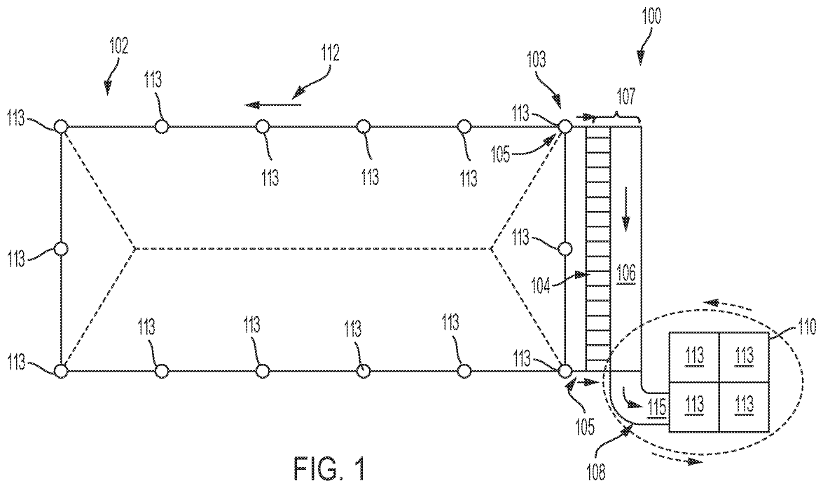

FIG. 1 illustrates an example end-wall catching system coupled to mobile poultry enclosure, in accordance with one or more implementations. End-wall catching system 100 may be removably coupled to mobile poultry enclosure 102. In some implementations, end-wall catching system 100 may be coupled to end-wall 103 and/or to mobile poultry enclosure 102 at or near end-wall 103. The end-wall catching system may comprise conveyor portion 107, a harvesting portion 110, a coupling portion 105, and/or other portions. In some implementations, mobile poultry enclosure 102 may be 100-500 foot long poultry enclosure and/or 20-200 feet wide. By way of one non-limiting example, mobile poultry enclosure 102 may be around 35 feet wide by around 216 feet long. Smaller and larger mobile poultry coops with varying dimensions and/or shapes (e.g., having a generally circular, pie shaped, square, rectangular, etc., foot print) are contemplated. Mobile poultry enclosure 102 may be disposed on a chassis and/or include multiple wheels 11 that enable the mobile poultry enclosure to move across a field in one or more directions (for example, in the direction of arrow 112).

Conveyor portion 107 may include lifting conveyor belt 104, transverse conveyor belt 106, and/or other conveyor belts. Lifting conveyor belt 104 may rotate and/or move to lift individual ones of the live poultry off a field on which mobile poultry enclosure 102 is disposed. Lifting conveyor belt 104 may move the individual ones of the live poultry to transverse conveyor belt 106. In some implementations, lifting conveyor belt 104 may be arranged perpendicular to transverse conveyor belt 106. As such, lifting conveyor belt 104 may lift the live poultry off the field, moving them horizontally to transverse conveyor belt 106. Lifting conveyor belt 104 may be configured to move the live poultry in the opposite direction in which mobile poultry enclosure 102 is moving.

In some implementations, lifting conveyor belt 104 may include multiple parallel segments of lifting conveyor belts 104. The multiple parallel segments may rotate towards transverse conveyor belt 106. By way of non-limiting example, the multiple segments may comprise multiple parallel, angled, and/or abutting conveyor belt segments that are 2-3.5 ft wide. The multiple parallel, angled, and/or abutting segments may be arranged next to each other such that they extend and/or nearly extend the length of end-wall 103 on and/or near which end-wall catching system 100 is disposed (e.g., 20-200 feet in length, for example 35 feet). By way of non-limiting example, lifting conveyor belt 104 may comprise 10-12 parallel, angled, and abutting segments of conveyor belts that rotate towards transverse conveyor belt 106. By way of another non-limiting example, lifting conveyor belt 104 may be disposed 12-20 inches off the ground and/or able to lift the live poultry off the field.

Transverse conveyor belt 106 may be arranged and/or disposed perpendicular to lifting conveyor belt 104 such that lifting conveyor belt 104 may converge to transverse conveyor belt 106 causing the live poultry to transfer from lifting conveyor belt 104 onto transverse conveyor belt 106. Once transferred from lifting conveyor belt 104 to transverse conveyor belt 106, transverse conveyor belt 106 may move the live poultry vertically (e.g., towards the center and/or a corner of the mobile poultry enclosure at and/or near end-wall 103). As such, the live poultry may be collected from the field as mobile poultry enclosure 102 moves, and transported to a specific area (e.g., the corner and/or center of end-wall 103) of mobile poultry enclosure 102 via lifting conveyor belt 104 and/or transverse conveyor belt 106. In some implementations, transverse conveyor belt 106 may run the length and/or nearly the length of end-wall 103 of mobile poultry enclosure 102 on and/or near where end-wall catching system 100 is disposed (i.e., the width of mobile poultry enclosure 102).

Harvesting portion 110 of end-wall catching system 100 may be disposed at a convergence of conveyor portion 107. For example, harvesting portion 110 may be located at or near the center and/or a corner of mobile poultry enclosure 102 at and/or near end-wall 103). Harvesting portion 110 may be configured to move individual ones of the live poultry into one or more crates 113. In some implementations, harvesting portion 110 of end-wall catching system 100 may comprise a movable harvesting conveyor belt 115 that moves the individual ones of the live poultry into the one or more crates 113. By way of non-limiting example, harvesting portion 108 may include multiple crates 113 disposed on a rotating platform 110 (e.g., underneath crates 113 in FIG. 1). Movable harvesting conveyor belt 115 may have an adjustable height that enables harvesting portion 108 to dispense live poultry into individual empty crates 113. The platform 110 may rotate to consistently provide an empty crate 113 disposed at the end of the movable harvesting conveyor belt.

End-wall catching system 100 may include coupling portion 105. Coupling portion 105 may be configured to removably couple end-wall catching system 100 to end-wall 103 of mobile poultry enclosure 102. Coupling portion 105 may include one or more of a hitch (e.g., a drop pin hitch, ball hitch, pintle hitch, and/or other hitch), a drop pin, a hook and/or loop, and/or any other coupling mechanism(s).

Responsive to mobile poultry enclosure 102 moving across a field, end-wall catching system 100 may move alongside and/or with mobile poultry enclosure 100. In some implementations, when mobile poultry enclosure 102 moves across the field in a direction longitudinal to the mobile poultry enclosure 102 (see arrow 112), end-wall catching system 100 moves across the field in a direction longitudinal to mobile poultry enclosure 102 (see arrow 112 for an example of a longitudinal direction for the orientation illustrated). By way of non-limiting example, if the end-walls of the mobile poultry enclosure comprise the west and east (e.g., end-wall 103 may be considered the east wall if, dependent on the orientation of the mobile poultry enclosure, the direction of movement illustrated by arrow 112 is west) ends of the mobile poultry enclosure, and the longitudinal walls comprise the north and south ends of the mobile poultry enclosure, mobile poultry enclosure 102 and/or end-wall catching system 100 may move across the field in an east and/or west (see e.g., arrow 112) direction (i.e., longitudinal to the mobile poultry enclosure). In some implementations, coupling portion 105 may be configured to couple end-wall catching system 100 to an exterior of end-wall 103 of mobile poultry enclosure 102.

In some implementations, one or more retaining fences inside mobile poultry enclosure and/or opposite end-wall catching system 100 may keep the like poultry from traveling away from the approaching end-wall catching system 100. Retaining fences may be put up prior to catching and/or taken down after and/or throughout catching.

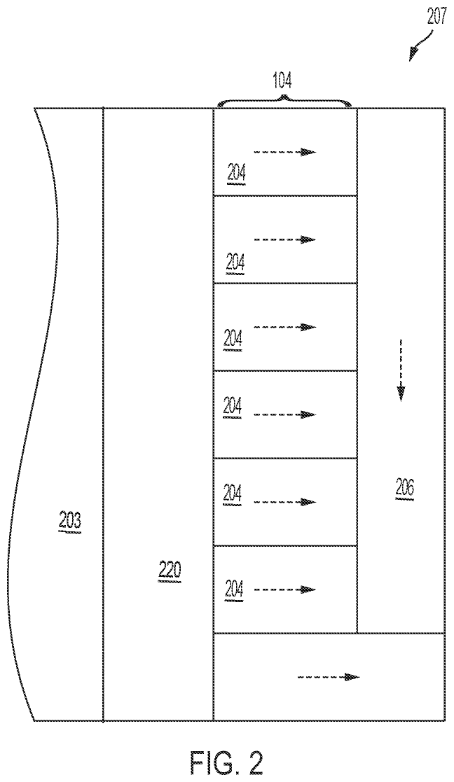

FIG. 2 illustrates a segment of a conveyor portion disposed at an exterior of an end-wall of the mobile poultry enclosure, in accordance with one or more implementations. Segment of conveyor portion 207 may include a segment of lifting conveyor belt 104 comprising multiple parallel, angled, and/or abutting lifting conveyor belt segments 204. The multiple parallel, angled, and/or abutting lifting conveyor belt segments 204 may be arranged next to each other. By way of non-limiting example, lifting conveyor belt 204 may comprise multiple parallel, angled, and abutting segments of lifting conveyor belts that rotate towards transverse conveyor belt 206. The multiple lifting conveyor belt segments 204 may converge to the transverse conveyor belt 206. By way of another non-limiting example, lifting conveyor belt 104 may be disposed 12-20 inches off the ground and/or able to lift the live poultry off the field. Skirt 220, on a bottom portion of end-wall 203 of the mobile poultry enclosure may be configured to lift such that when the mobile poultry enclosure moves across the field, the individual ones of the live poultry pass under end-wall 203 to lifting conveyor belt 204.

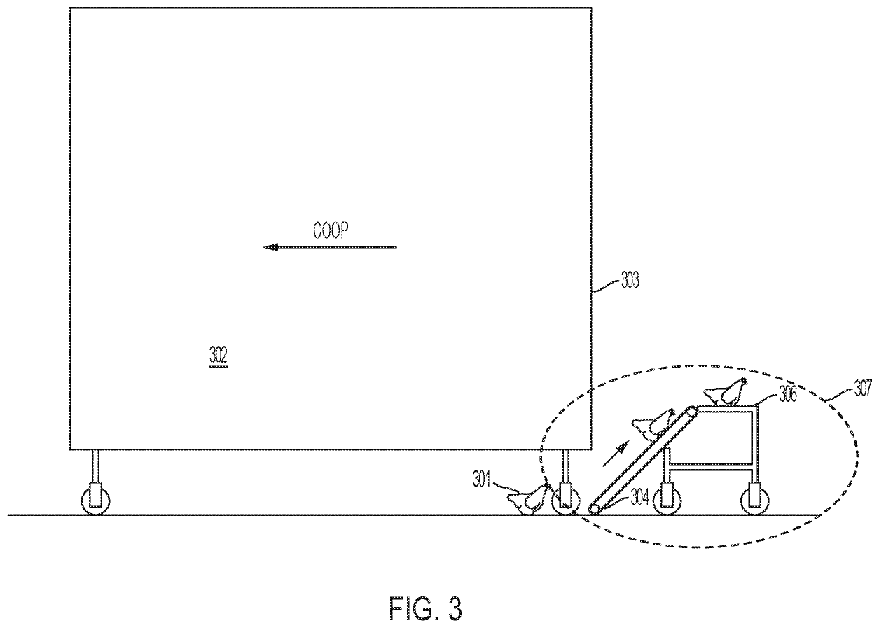

FIG. 3 illustrates a side view of a conveyor portion disposed at an exterior of an end-wall of the mobile poultry enclosure, in accordance with one or more implementations. Conveyor portion 307 may include lifting conveyor belt 304 comprising multiple parallel, angled, and/or abutting lifting conveyor belt segments. The multiple parallel, angled, and/or abutting lifting conveyor belt segments may be arranged next to each other. By way of non-limiting example, lifting conveyor belt 304 may comprise multiple parallel, angled, and abutting segments of lifting conveyor belts that rotate towards transverse conveyor belt 306. The multiple lifting conveyor belt segments may converge to the transverse conveyor belt 306. By way of another non-limiting example, lifting conveyor belt 304 may be disposed 12-20 inches off the ground and/or able to lift the live poultry 301 off the field. Skirt 320, on a bottom portion of end-wall 303 of the mobile poultry enclosure 302 may be configured to lift such that when mobile poultry enclosure 302 moves across the field in the direction of arrow 305, the individual ones of the live poultry pass under end-wall 303 to lifting conveyor belt 304 such that they are gathered by the end-wall catching system.

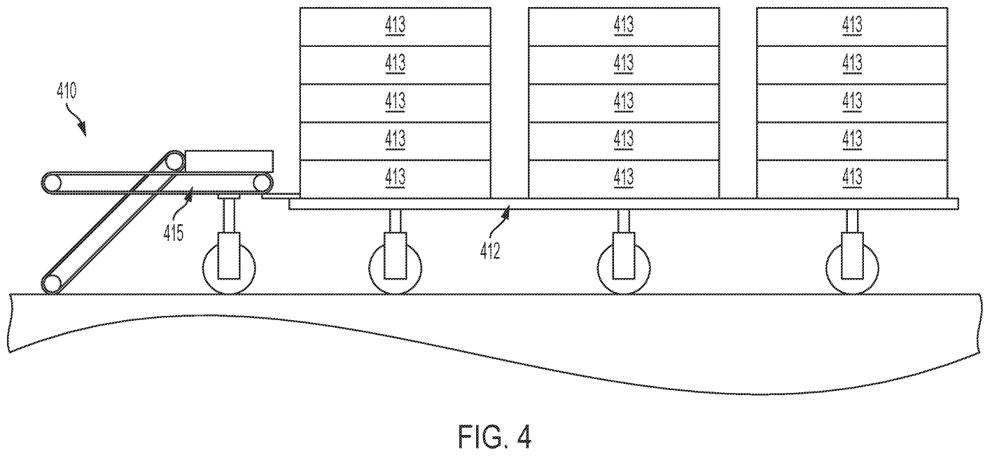

FIG. 4 illustrates a side view of the harvesting portion 410 of the end-wall catching system with one or more crates, in accordance with one or more implementations. Harvesting portion 410 may be configured to move individual ones of the live poultry into one or more crates 413. In some implementations, harvesting portion 410 may comprise a movable harvesting conveyor belt 415 that moves the individual ones of the live poultry into the one or more crates 413. Moveable harvesting conveyor belt 415 may be configured to raise and/or lower to feed live poultry into one or more stacked crates 413. By way of non-limiting example, the multiple crates 413 may be stacked and/or disposed on a rotating platform 412. Movable harvesting conveyor belt 415 may have an adjustable height that enables harvesting portion 410 to feed live poultry into individual empty crates 413. The rotating platform 412 may rotate to consistently provide an empty crate 413 disposed at the end of the movable harvesting conveyor belt 415.

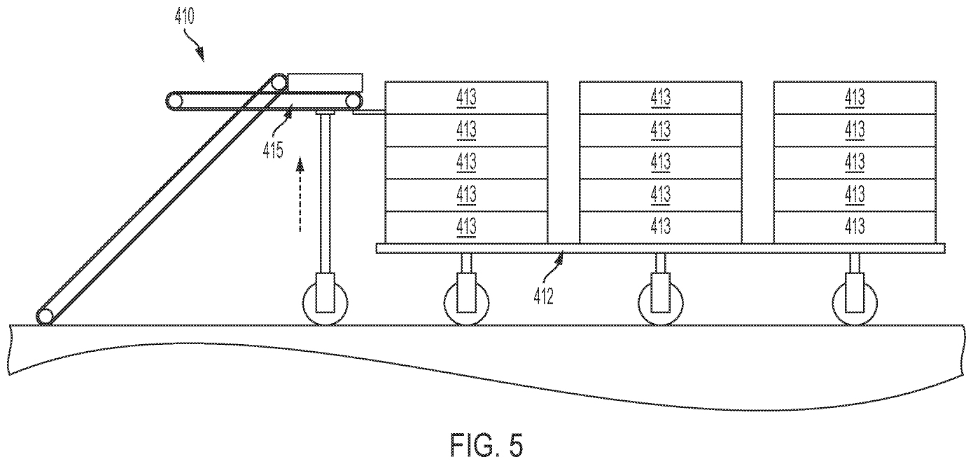

FIG. 5 illustrates a side view of the harvesting portion of the end-wall catching system with one or more crates including a raised moveable harvesting conveyor belt 415, in accordance with one or more implementations. By way of non-limiting example, moveable harvesting conveyor belt 415 may be configured to raise (see e.g., height of moveable harvesting conveyor belt 415 in FIG. 4 compared to FIG. 5) to feed live poultry into one or more stacked crates 415. The multiple crates 413 may be stacked and/or disposed on a rotating platform 412. Movable harvesting conveyor belt 415 may have an adjustable height that enables harvesting portion 410 to feed live poultry into individual empty crates 413. The rotating platform 412 may rotate to consistently provide an empty crate 413 disposed at the end of the movable harvesting conveyor belt 415.

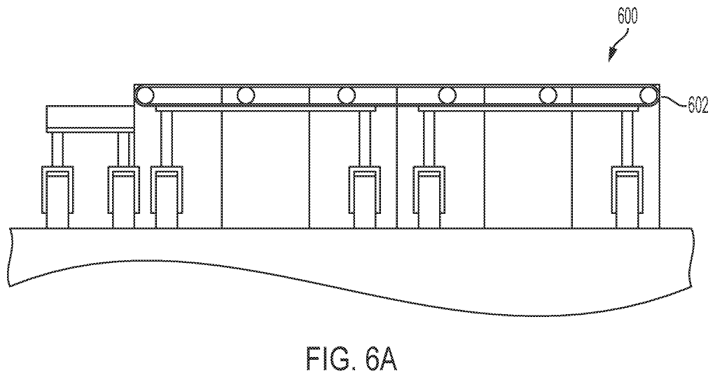

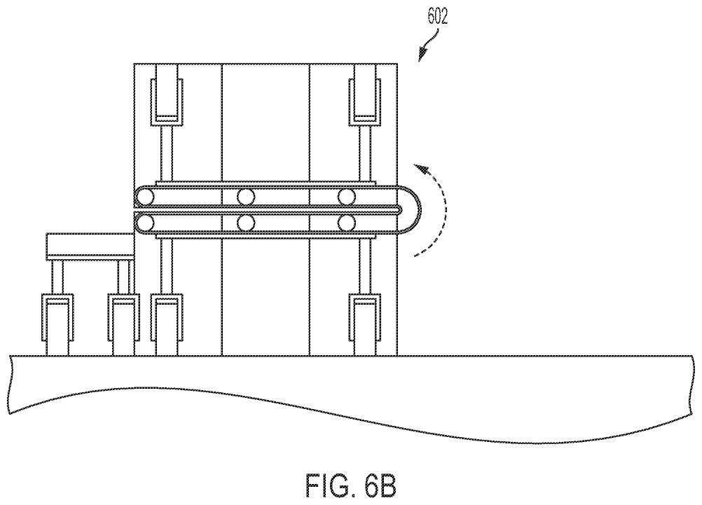

FIG. 6A illustrates a side view of the end-wall catching system 600, in accordance with one or more implementations. In some implementations, the end-wall catching system may be collapsible. For example, the conveyor portion 600 may be collapsible into a stored position and/or the harvesting portion may be detachable. The stored position may have a smaller surface area and/or footprint than a deployed position.

FIG. 6B illustrates a side view of the end-wall catching system in a collapsed position 602, in accordance with one or more implementations. In some implementations, the end-wall catching system may be collapsible and/or foldable. For example, the conveyor portion 602 may be folded and/or collapsed into a stored position and/or the harvesting portion may be detachable. The stored position may have a smaller exposed surface area and/or footprint than a deployed position.

FIG. 6C illustrates a top view the end-wall catching system in a collapsed position with the conveyor portion 604 collapsed and/or loaded onto flatbed trailer 606, in accordance with one or more implementations. The collapsed position may have a smaller exposed surface area and/or footprint than a deployed position such that it can be loaded onto flatbed trailer 606. Collapsing the end-wall catching system and/or conveyor portion 604 into a collapsed and/or stored position may enable more efficient transportation of the end-wall catching system to the mobile poultry enclosure disposed on a field.

By way of non-limiting example, the end-wall catching system may not include a motor and/or drive system enabling it to be lighter and/or more compact that traditional catching systems. Continuing the non-limiting use example, the end-wall catching system may be transported to the mobile poultry enclosure disposed on a field via a trailer (e.g., a flatbed trailer 606), a forklift, a truck, and/or other transportation systems and/or mechanisms. Removing the drive and/or steering capabilities from traditional catching machines may enable a lighter catching machine and/or facilitate rapid movement with standard equipment such as a forklift, trailer, and/or truck saving cost and/or time when transporting the end-wall catching machine to multiple locations where individual mobile poultry enclosures are disposed on a field.

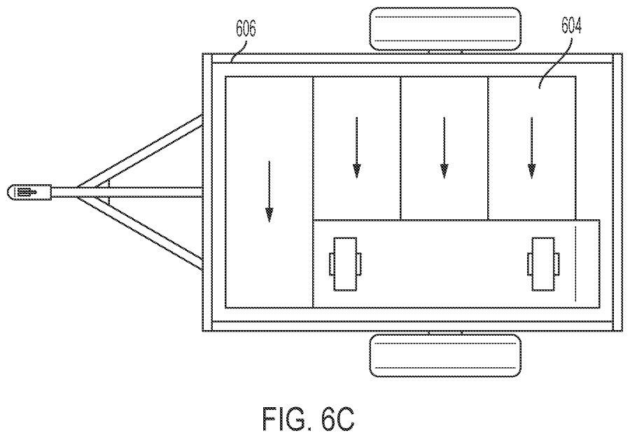

FIG. 7 illustrates a method for removably coupling an end-wall catching system to an end-wall of a mobile poultry enclosure and gathering and/or crating live poultry, in accordance with one or more implementations. The operations of method 700 presented below are intended to be illustrative. In some embodiments, method 700 may be accomplished with one or more additional operations not described, and/or without one or more of the operations discussed. Additionally, the order in which the operations of method 700 illustrated in FIG. 7 and described below is not intended to be limiting.

In some embodiments, method 700 may be implemented by one or more components of an end-wall catching system configured to removably couple to an end-wall of a mobile poultry enclosure and gather and/or crate live poultry. The one or more components of the system may a conveyor portion, harvesting portion, coupling portion, and/or other portions.

At an operation 702, the method may include coupling the end-wall catching system to an end-wall of the mobile poultry enclosure. As such, responsive to the mobile poultry enclosure moving across a field, the end-wall catching system may move alongside and/or with the mobile poultry enclosure. In some implementations, operation 702 may be performed by a coupling portion the same as or similar to coupling portion 105 (shown in FIG. 1 and described herein).

At an operation 704, the method may include rotating a lifting conveyor belt of the end-wall catching system to lift individual ones of the live poultry off a field on which the mobile poultry enclosure is disposed. The lifting conveyor belt may be rotated to move the individual ones of the live poultry to a transverse conveyor belt. In some implementations, operation 704 may be performed by a lifting conveyor belt the same as or similar to lifting conveyor belt 104 (shown in FIG. 1 and described herein).

At an operation 706, the method may include rotating a transverse conveyor belt of the end-wall catching system to move the individual ones of the live poultry to a harvesting portion. The transverse conveyor belt may be arranged perpendicular to the lifting conveyor belt. In some implementations, operation 706 may be performed by a transverse conveyor belt the same as or similar to transverse conveyor belt 106 (shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. An end-wall catching system configured to removably couple to an end-wall of a mobile poultry enclosure and gather and/or crate live poultry, the end-wall catching system comprising:
a conveyor portion including a lifting conveyor belt and a transverse conveyor belt, wherein the lifting conveyor belt rotates to lift individual ones of the live poultry off a field on which the mobile poultry enclosure is disposed and moves the individual ones of the live poultry to the transverse conveyor belt, the lifting conveyor belt arranged perpendicular to the transverse conveyor belt, wherein the transverse conveyor belt rotates to move the individual ones of the live poultry to a harvesting portion;
the harvesting portion disposed at a convergence of the conveyor portion, the harvesting portion moving the individual ones of the live poultry into one or more crates; and
a coupling portion configured to couple the end-wall catching system to an end-wall of the mobile poultry enclosure such that responsive to the mobile poultry enclosure moving across a field, the end-wall catching system moves alongside and/or with the mobile poultry enclosure.

2. The end-wall catching system of claim 1, wherein the lifting conveyor belt includes multiple parallel segments of lifting conveyor belts that rotate towards the transverse conveyor belt.

3. The end-wall catching system of claim 1, wherein the mobile poultry enclosure moves across the field in a direction longitudinal to the mobile poultry enclosure.

4. The end-wall catching system of claim 1, wherein the harvesting portion comprises a movable harvesting conveyor belt that moves the individual ones of the live poultry into the one or more crates.

5. The end-wall catching system of claim 1, wherein the end-wall catching system is collapsible such that the conveyor portion is collapsible into a stored position and/or the harvesting portion is detachable.

6. The end-wall catching system of claim 1, wherein the coupling portion is configured to couple the end-wall catching system to an exterior of the end-wall of the mobile poultry enclosure such that responsive to a skirt on a bottom portion of the end-wall being lifted and the mobile poultry enclosure moving across the field, the individual ones of the live poultry pass under the end-wall to be lifted off the field by the lifting conveyor belt.

7. The end-wall catching system of claim 1, wherein the coupling portion is configured to couple the end-wall catching system to an interior of the end-wall of the mobile poultry enclosure such that responsive to the mobile poultry enclosure moving across the field, the individual ones of the live poultry are lifted off the field by the lifting conveyor belt.

8. The end-wall catching system of claim 1, wherein the transverse conveyor belt is 2-4 feet wide and/or 18-24 inches off the ground.

9. The end-wall catching system of claim 1, wherein the harvesting portion includes a movable harvesting conveyor belt that has an adjustable height for moving the individual ones of the live poultry into the one or more crates.

10. The end-wall catching system of claim 1, wherein the one or more crates are on one or more rotating platforms.

11. A method for removably coupling an end-wall catching system to an end-wall of a mobile poultry enclosure and gathering and/or crating live poultry, the method comprising:
coupling the end-wall catching system to an end-wall of the mobile poultry enclosure such that responsive to the mobile poultry enclosure moving across a field, the end-wall catching system moves alongside and/or with the mobile poultry enclosure;
rotating a lifting conveyor belt of the end-wall catching system to lift individual ones of the live poultry off a field on which the mobile poultry enclosure is disposed and move the individual ones of the live poultry to a transverse conveyor belt; and
rotating the transverse conveyor belt, arranged perpendicular to the lifting conveyor belt, to move the individual ones of the live poultry to a harvesting portion.

12. The method of claim 11, wherein rotating the lifting conveyor belt includes rotating multiple parallel segments of lifting conveyor belts towards the transverse conveyor belt.

13. The method of claim 11, further comprising moving the mobile poultry enclosure across the field in a direction longitudinal to the mobile poultry enclosure.

14. The method of claim 11, further comprising moving the individual ones of the live poultry into the one or more crates via a movable conveyor belt.

15. The method of claim 11, further comprising collapsing a conveyor portion of the end-wall catching system, including the lifting conveyor belt and the transverse conveyor belt, into a stored position and/or detaching the conveyor portion from the harvesting portion.

16. The method of claim 11, further comprising lifting a skirt on a bottom portion of the end-wall and moving the mobile poultry enclosure across the field such that the individual ones of the live poultry pass under the end-wall and are lifted off the field by the lifting conveyor belt.
